(19) United States
(12) Patent Application Publication
(10) Pub. No.: US 2025/0007798 A1
(43) Pub. Date: Jan. 2, 2025

(54) ANALYTICS IN A COMMUNICATION NETWORK

(71) Applicant: Telefonaktiebolaget LM Ericsson (publ), Stockholm (SE)

(72) Inventors: Miguel Angel MUÑOZ DE LA TORRE, Madrid (ES); Javier CAMPO TRAPERO, Madrid (ES)

(21) Appl. No.: 18/710,316

(22) PCT Filed: Dec. 21, 2021
(86) PCT No.: PCT/IB2021/062125

§ 371 Date: May 15, 2024

(30) Foreign Application Priority Data
Nov. 17, 2021 (EP) 21383043.3

(51) Int. Cl. H04L 43/062; H04L 43/0876; H04W 24/02

(52) U.S. Cl. CPC H04L 43/062; H04L 43/0876; H04W 24/02

(57) ABSTRACT

A network node is configured for use in a communication network. The network node receives, from a consumer node in the communication network, a request for analytics that characterize misclassification of user plane application traffic by the communication network. The network node generates analytics according to this request and transmits the generated analytics to the consumer node as a response to the request. Based on the analytics, the consumer node in some embodiments may perform one or more actions to account for, and/or mitigate an impact of, user plane application traffic misclassification characterized by the analytics.

### TECHNICAL FIELD

The present application relates generally to a communication network, and relates more particularly to analytics in such a network.

### BACKGROUND

A traffic classifier in a communication network evaluates user plane application traffic to determine to which application the traffic relates. A traffic classifier thereby classifies user plane application traffic according to the application to which the traffic relates. A traffic classifier may for example use deep packet inspection to identify certain characteristics about the traffic that suggest from which application the traffic originates. With traffic classified on an application by application basis, the communication network may advantageously apply application-specific treatment rules to the traffic, charge subscribers on the basis of per-application traffic volume, or the like.

Challenges nonetheless exist in realizing reliable traffic classification. Indeed, traffic classification must adapt to changing circumstances, such as the evolution of an application from one version to another, in order to avoid misclassifying traffic as relating to the wrong application. Even if traffic misclassification can be detected and remedied, the delay required to do so risks improper traffic handling, incorrect subscriber charging, etc. in the interim.

### SUMMARY

Some embodiments herein enable a communication network to generate analytics that characterize misclassification of user plane application traffic by the communication network. One or more embodiments in this regard define such traffic misclassification analytics as one of multiple standardized types of analytics that can be requested, e.g., as part of an analytics service and/or on a subscription or event-triggered basis. These and other embodiments may thereby facilitate automated and/or timely (e.g., real-time) detection of traffic misclassification, so as to minimize the risk of improper traffic handling, incorrect subscriber charging, etc.

More particularly, embodiments herein include a method performed by a network node in a communication network. The method comprises receiving, from a consumer node in the communication network, a request for analytics that characterize misclassification of user plane application traffic by the communication network, generating analytics according to the request, and transmitting the generated analytics to the consumer node as a response to the request.

In some embodiments, the method further comprises receiving network classification information that characterizes classification of user plane application traffic by the communication network, and determining, based on the network classification information, an extent to which the communication network is misclassifying user plane application traffic. In this case, the analytics are generated based on the determined extent. In one or more of these embodiments, network classification information comprises, for each of one or more applications, an identifier that identifies the application, and a copy of user plane application traffic classified as being traffic of the identified application and/or descriptive data that describes the user plane application traffic classified as being traffic of the identified application.

In one or more of these embodiments the method further comprises receiving, for each of one or more communication devices, device-reported application information reported by the communication device as characterizing user plane application traffic for each of one or more applications at the communication device. In this case, determining is also based on the device-reported application information. In one or more of these embodiments, determining an extent to which the communication network is misclassifying user plane application traffic is also based on a trained machine learning model. In this case, the method further comprises training the machine learning model to detect user plane application traffic misclassification based on recognizing patterns in how user plane application traffic classification changes across different traffic classification models and/or application versions.

Other embodiments herein include a method performed by a consumer node in a communication network. The method comprises transmitting, from the consumer node to a network node in the communication network, a request for analytics that characterize misclassification of user plane application traffic by the communication network, and receiving the analytics from the network node as a response to the request.

In some embodiments, the method further comprises, based on the analytics, performing one or more actions to account for, and/or mitigate an impact of, user plane application traffic misclassification characterized by the received analytics. In one or more of these embodiments, the one or more actions include one or more of triggering re-training of a machine learning model that governs user plane application traffic classification by the communication network, triggering an alarm or warning indicating occurrence of misclassification of user plane application traffic by the communication network, increasing a counter indicating a number of occurrences of misclassification of user plane application traffic by the communication network, or adjusting charging to account for misclassification of user plane application traffic by the communication network.

In some of these embodiments, the request includes an analytic identifier parameter. In this case, different possible values of the analytic identifier parameter are mapped to different respective types of analytics, and the analytic identifier parameter included in the request is set to one of the possible values which is mapped to a type of analytics that characterizes misclassification of user plane application traffic by the communication network.

In some embodiments, the request comprises a request for analytics that characterize misclassification of user plane application traffic associated with one or more targeted applications, and/or one or more targeted communication devices or one or more targeted groups of communication devices, and/or one or more targeted data network names, and/or one or more targeted network slices of the communication network, and/or one or more areas of interest within a geographical coverage area of the communication network, and/or one or more access technologies usable for accessing the communication network.

In some embodiments, the analytics indicate an extent to which the communication network has misclassified user plane application traffic, and for which one or more applications and/or for which one or more communication devices user plane application traffic has been misclassified.

In some embodiments, the analytics indicate, for each of one or more applications a volume of user plane application traffic misclassified for that application, and/or a level of confidence that user plane application traffic has been misclassified for the application. In one or more of these embodiments, the analytics further indicate, for each of the one or more applications, a model used for classifying user plane application traffic for that application, and/or an identity of the application, and/or a list of one or more versions of the application for which the generated analytics apply.

In some embodiments, misclassification of user plane application traffic by the communication network comprises misclassification of user plane application traffic for one application as being user plane application traffic for another application.

Other embodiments herein include a network node configured for use in a communication network. The network node is configured to receive, from a consumer node in the communication network, a request for analytics that characterize misclassification of user plane application traffic by the communication network, generate analytics according to the request, and transmit the generated analytics to the consumer node as a response to the request.

In some embodiments, the network node is configured to perform the steps described above for a network node.

Other embodiments herein include a consumer node configured for use in a communication network. The consumer node is configured to transmit, from the consumer node to a network node in the communication network, a request for analytics that characterize misclassification of user plane application traffic by the communication network, and receive the requested analytics from the network node as a response to the request.

In some embodiments, the consumer node is configured to perform the steps described above for a consumer node.

Other embodiments herein include a computer program comprising instructions which, when executed by at least one processor of a network node configured for use in a communication network, causes the network node to perform the steps described above for a network node. Other embodiments herein include a computer program comprising instructions which, when executed by at least one processor of a consumer node configured for use in a communication network, causes the consumer node to perform the steps described above for a consumer node. In one or more of these embodiments, a carrier containing the computer program is one of an electronic signal, optical signal, radio signal, or computer readable storage medium.

Other embodiments herein include a network node configured for use in a communication network. The network node comprises communication circuitry and processing circuitry. The processing circuitry is configured to receive, from a consumer node in the communication network, a request for analytics that characterize misclassification of user plane application traffic by the communication network, generate analytics according to the request, and transmit the generated analytics to the consumer node as a response to the request.

In some embodiments, the processing circuitry is configured to perform the steps described above for a network node.

Other embodiments herein include a consumer node configured for use in a communication network. The consumer node comprises communication circuitry and processing circuitry. The processing circuitry is configured to transmit, from the consumer node to a network node in the communication network, a request for analytics that characterize misclassification of user plane application traffic by the communication network, and receive the requested analytics from the network node as a response to the request.

In some embodiments, the processing circuitry is configured to perform the steps described above for a consumer node.

Other embodiments herein include a method performed by a network node in a communication network. The method comprises transmitting, to a user plane network node in the communication network, an event subscription request that requests the user plane network node to report network classification information that characterizes classification of user plane application traffic by the user plane network node, and receiving the network classification information according to the event subscription request.

In some embodiments, the method further comprises based on the network classification information, generating analytics characterizing misclassification of user plane application traffic by the user plane network node.

Other embodiments herein include a method performed by a user plane network node in a communication network. The method comprises receiving, from a network node in the communication network, an event subscription request that requests the user plane network node to report network classification information that characterizes classification of user plane application traffic by the user plane network node, and reporting the network classification information to the network node according to the event subscription request.

In some embodiments, the event subscription request includes an event identifier parameter. In this case, different possible values of the event identifier parameter are mapped to different respective types of events, and the event identifier parameter included in the event subscription request is set to one of the possible values which is mapped to a type of event that characterizes classification of user plane application traffic by the user plane network node.

In some embodiments, the event subscription request requests the user plane network node to report network classification information that characterizes classification of user plane application traffic associated with, and/or one or more targeted communication devices or one or more targeted groups of communication devices.

In some embodiments, the event subscription request requests the user plane network node to report network classification information that characterizes classification of user plane application traffic according to a traffic classification model specified by the event subscription request.

In some embodiments, the network classification information comprises, for each of one or more applications, an identifier that identifies the application, and a copy of user plane application traffic classified as being traffic of the identified application and/or descriptive data that describes the user plane application traffic classified as being traffic of the identified application.

Other embodiments herein include a network node configured for use in a communication network. The network node is configured to transmit, to a user plane network node in the communication network, an event subscription request that requests the user plane network node to report network classification information that characterizes classification of user plane application traffic by the user plane network node, and receive the network classification information according to the event subscription request.

In some embodiments, the network node is configured to perform the steps described above for a network node and a user plane network node.

Other embodiments herein include a user plane network node configured for use in a communication network. The user plane network node is configured to receive, from a network node in the communication network, an event subscription request that requests the user plane network node to report network classification information that characterizes classification of user plane application traffic by the user plane network node, and report the network classification information to the network node according to the event subscription request.

In some embodiments, the user plane network node is configured to perform the steps described above for a user plane network node.

Other embodiments herein include a computer program comprising instructions which, when executed by at least one processor of a network node configured for use in a communication network, causes the network node to perform the steps described above for a network node and a user plane network node. Other embodiments herein include a computer program comprising instructions which, when executed by at least one processor of a user plane network node configured for use in a communication network, causes the user plane network node to perform the steps described above for a user plane network node. In one or more of these embodiments, a carrier containing the computer program is one of an electronic signal, optical signal, radio signal, or computer readable storage medium.

Other embodiments herein include a network node configured for use in a communication network. The network node comprises communication circuitry and processing circuitry. The processing circuitry is configured to transmit, to a user plane network node in the communication network, an event subscription request that requests the user plane network node to report network classification information that characterizes classification of user plane application traffic by the user plane network node, and receive the network classification information according to the event subscription request.

In some embodiments, the processing circuitry is configured to perform the steps described above for a network node and a user plane network node.

Other embodiments herein include a user plane network node configured for use in a communication network. The user plane network node comprises communication circuitry and processing circuitry. The processing circuitry is configured to receive, from a network node in the communication network, an event subscription request that requests the user plane network node to report network classification information that characterizes classification of user plane application traffic by the user plane network node, and report the network classification information to the network node according to the event subscription request.

In some embodiments, the processing circuitry is configured to perform the steps described above for a user plane network node.

Other embodiments herein include a method performed by a network node in a communication network. The method comprises transmitting, to a communication device, an event subscription request that requests the communication device to report application information that characterizes user plane application traffic for each of one or more applications at the communication device, and receiving the application information according to the event subscription request.

In some embodiments, the method further comprises, based on the application information, generating analytics characterizing misclassification of user plane application traffic by a user plane network node in the communication network.

Other embodiments herein include a method performed by a communication device. The method comprises receiving, from a network node in a communication network, an event subscription request that requests the communication device to report application information that characterizes user plane application traffic for each of one or more applications at the communication device, and transmitting the application information to the network node according to the event subscription request.

In some embodiments, the application information indicates, for each of the one or more applications at the communication device, an identity of the application as assigned by an operating system of the communication device and/or a version of the application installed on the communication device, and a volume of user plane application traffic communicated for the application.

In some embodiments, the application information indicates, for each of the one or more applications at the communication device, a protocol stack via which user plane application traffic for the application was communicated, and/or timing information indicating when user plane application traffic for the application was communicated, and/or connection information describing a transport layer connection via which user plane application traffic for the application was communicated.

Other embodiments herein include a network node configured for use in a communication network. The network node is configured to transmit, to a communication device, an event subscription request that requests the communication device to report application information that characterizes user plane application traffic for each of one or more applications at the communication device, and receive the application information according to the event subscription request.

In some embodiments, the network node is configured to perform the steps described above for a network node.

Other embodiments herein include a communication device configured to receive, from a network node in a communication network, an event subscription request that requests the communication device to report application information that characterizes user plane application traffic for each of one or more applications at the communication device, and transmit the application information to the network node according to the event subscription request.

In some embodiments, the communication device is configured to perform the steps described above for a communication device.

Other embodiments herein include a computer program comprising instructions which, when executed by at least one processor of a network node configured for use in a communication network, causes the network node to perform the steps described above for a network node and a communication device. Other embodiments herein include a computer program comprising instructions which, when executed by at least one processor of a communication device configured for use in a communication network, causes the communication device to perform the steps described above for a communication device and a network node. In one or more of these embodiments, a carrier containing the computer program is one of an electronic signal, optical signal, radio signal, or computer readable storage medium.

Other embodiments herein include a network node configured for use in a communication network. The network node comprises communication circuitry and processing circuitry. The processing circuitry is configured to transmit, to a communication device, an event subscription request that requests the communication device to report application information that characterizes user plane application traffic for each of one or more applications at the communication device, and receive the application information according to the event subscription request.

In some embodiments, the processing circuitry is configured to perform the steps described above for a network node.

Other embodiments herein include a communication device configured for use in a communication network comprising communication circuitry and processing circuitry. The processing circuitry is configured to receive, from a network node in a communication network, an event subscription request that requests the communication device to report application information that characterizes user plane application traffic for each of one or more applications at the communication device, and transmit the application information to the network node according to the event subscription request.

In some embodiments, the processing circuitry is configured to perform the steps described above for a communication device.

### BRIEF DESCRIPTION OF THE DRAWINGS

FIG. 1 is a block diagram of a communication network in accordance with some embodiments.

FIG. 2 is a call flow diagram of a procedure for traffic misclassification analytics generation in a communication network according to some embodiments.

FIGS. 3A-3B are call flow diagrams for machine learning model training for traffic misclassification analytic generation according to some embodiments.

FIGS. 4A-4B are call flow diagrams for traffic misclassification analytics generation based on classification by a UPF according to some embodiments.

FIGS. 5A-5B are call flow diagrams for traffic misclassification analytics generation based on classification by an NWDAF according to some embodiments.

FIG. 6 is a logic flow diagram of a method performed by a network node according to some embodiments.

FIG. 7 is a logic flow diagram of a method performed by a consumer node according to some embodiments.

FIG. 8 is a logic flow diagram of a method performed by a network node according to other embodiments.

FIG. 9 is a logic flow diagram of a method performed by a user plane network node according to some embodiments.

FIG. 10 is a logic flow diagram of a method performed by a network node according to some embodiments.

FIG. 11 is a logic flow diagram of a method performed by a communication device according to some embodiments.

FIG. 12 is a block diagram of a communication device according to some embodiments.

FIG. 13 is a block diagram of a network node according to some embodiments.

FIG. 14 is a block diagram of a user plane network node according to some embodiments.

FIG. 15 is a block diagram of a consumer node according to some embodiments.

FIG. 16 is a block diagram of a communication system in accordance with some embodiments

FIG. 17 is a block diagram of a user equipment according to some embodiments.

FIG. 18 is a block diagram of a network node according to some embodiments.

FIG. 19 is a block diagram of a host according to some embodiments.

FIG. 20 is a block diagram of a virtualization environment according to some embodiments.

FIG. 21 is a block diagram of a host communicating via a network node with a UE over a partially wireless connection in accordance with some embodiments.

### DETAILED DESCRIPTION

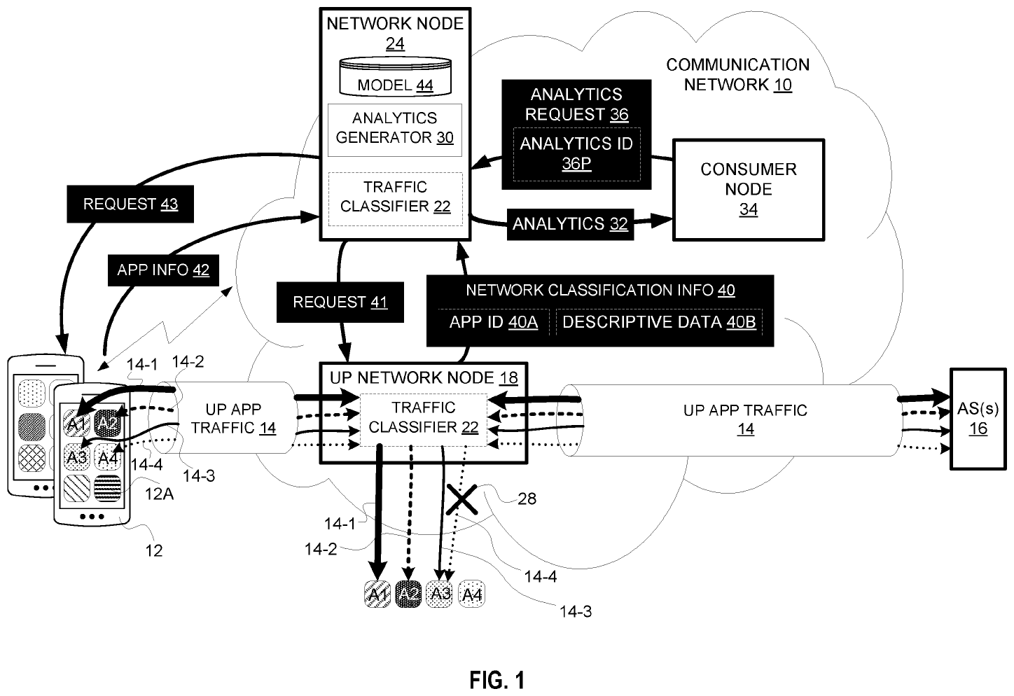

FIG. 1 shows a communication network 10 that provides communication service to one or more communication devices 12. The communication network 10 may for instance be a wireless communication network, e.g., a 5G wireless network, and the communication device(s) 12 may be wireless communication device(s).

Each communication device 12 as shown executes one or more applications 12A, i.e., one or more ‘apps’. An application 12A as used herein refers to a computer program designed to carry out a specific task other than one relating to the operation of a communication device 12 itself. Applications 12A may for instance include a Facebook® application, an Amazon® application, a Spotify® application, or the like. In some embodiments, an application 12A at any given time may be either active or inactive, e.g., where an active application is one that is currently executing and in the foreground whereas an inactive application is one that is either not currently executing or is currently executing but only in the background. Whether active or inactive, an application 12A at a communication device 12 may transmit and/or receive traffic 14, via the communication network 10, to or from one or more application servers 16 that may be deployed internal to or external to the communication network 10. Where the communication network 10 transports this traffic 14 via a user plane (UP), the traffic 14 may be appropriately referred to as UP application traffic 14. In the example of FIG. 1, for instance, application A1 transmits and/or receives UP application traffic 14-1, application A2 transmits and/or receives UP application traffic 14-2, application A3 transmits and/or receives UP application traffic 14-3, and application A4 transmits and/or receives UP application traffic 14-4.

The communication network 10 as shown in this regard includes a UP network node 18 that is on in the user plane communication path between the communication device(s) 12 and the one or more application servers 16. In this user plane communication path, the UP network node 18 handles UP application traffic 14, e.g., by performing packet routing and forwarding, handling quality of service (QOS) treatment, enforcing user plane policy rules, serving as an external Protocol Data Unit (PDU) session point of interconnect to an external application server, etc. The UP network node 18 may for instance implement a User Plane Function (UPF) in embodiments where the communication network 10 is a 5G network. In any event, the UP network node 18 effectively relays or forwards UP application traffic 14 between application(s) 12A executing at communication device(s) 12 and the one or more application servers 16.

FIG. 1 shows that the communication network 10 further includes a traffic classifier 22. In some embodiments, the traffic classifier 22 is implemented by the UP network node 18 itself. Or, in other embodiments, another network node 24 implements the traffic classifier 22 and the UP network node 18 mirrors the UP application traffic 14 to the network node 24 for classification by the traffic classifier 22. Regardless, the traffic classifier 22 evaluates the UP application traffic 14 (e.g., using deep packet inspection) to determine to which application 12A the traffic 14 relates. The traffic classifier 22 thereby classifies UP application traffic 14 according to the application 12A to which the traffic 14 relates. As shown in FIG. 1, for instance, the traffic classifier 22 may classify UP application traffic 14-1 as relating to application A1, classify UP application traffic 14-2 as relating to application A2, and classify UP application traffic 14-3 as relating to application A3.

However, the traffic classifier 22 may misclassify UP application traffic 14 under some circumstances, such as when the characteristics of or the patterns in an application's traffic changes due to the evolution of the application from one version to another. Under these circumstances, then, the traffic classifier 22 may misclassify UP application traffic by classifying the traffic as relating to the wrong application. That is, misclassification of UP application traffic 14 by the communication network 10 refers to misclassification of UP application traffic for one application as being UP application traffic for another application. As shown in the example of FIG. 1, for instance, the traffic classifier 22 misclassifies UP application traffic 14-4 as relating to application A3 instead of as relating to application A4. Such traffic misclassification 28 may for example occur when the communication device 12 updates the application A3 to the latest version.

Some embodiments herein enable the communication network 10 to generate analytics that characterize misclassification of UP application traffic 14 by the communication network 10. One or more embodiments in this regard may define such traffic misclassification analytics as one of multiple standardized types of analytics that can be requested, e.g., as part of an analytics service and/or on a subscription or event-triggered basis. These and other embodiments may thereby facilitate automated and/or timely (e.g., real-time) detection of traffic misclassification, so as to minimize the risk of improper traffic handling, incorrect subscriber charging, etc.

FIG. 1 in this regard shows that network node 24, e.g., via analytics generator 30, generates analytics 32 that characterize misclassification of UP application traffic 14 by the communication network 10. The analytics 32 may for instance characterize for which applications 12A UP application traffic 14 has been misclassified, for which communication device(s) 12 UP application traffic 14 has been misclassified, the volume of UP application traffic 14 misclassified per application 12A, or otherwise characterize an extent to which the communication network 10 has misclassified UP application traffic 14. Regardless, the network node 24 makes these analytics 32 available for consumption by a consumer node 34 in the communication network 10, e.g., as part of an analytics service and/or on a subscription or event-triggered basis. Based on the analytics 32, then, the consumer node 34 may perform one or more actions to account for, and/or mitigate an impact of, UP application traffic misclassification characterized by the analytics 32. The action(s) may instance include triggering an alarm or warning indicating occurrence of traffic misclassification, increasing a counter indicating a number of occurrences of traffic misclassification, and/or adjusting charging to account for traffic misclassification.

As shown in FIG. 1, for instance, the consumer node 34 transmits a request 36 for analytics 32 that characterize misclassification of UP application traffic 14 by the communication network 10. In fact, in some embodiments, the requested analytics 32 is one of multiple standardized types of analytics that can be requested. In these and other embodiments, the analytics request 36 may include an analytic identifier parameter 36P, where different possible values of the analytic identifier parameter 36P are mapped to different respective types of analytics. To request analytics 32 that characterize traffic misclassification, then, the analytic identifier parameter 36P included in the request 36 is set to one of the possible values which is mapped to a type of analytics that characterizes misclassification of UP application traffic 14 by the communication network 10. For example, the analytic identifier parameter 36P may be named “Analytic-ID” and be set to a value of “TrafficMisclassification”.

In some embodiments, the request 36 requests analytics 32 that characterize misclassification of UP application traffic 14 associated with one or more targeted applications, e.g., so that the analytics 32 are specific to only those one or more targeted applications. Where for instance different applications 12A are identified by respective application identifiers, the request 36 may include one or more application identifiers of the one or more targeted applications. Regardless, as an example, if the request 36 specifies the Facebook® application as being targeted, this means that the request 36 requests analytics 32 that selectively characterize misclassification of UP application traffic 14 associated with the Facebook® application, e.g., characterize misclassification of UP application traffic 14 for the Facebook® application as being UP application traffic for the wrong application and/or characterize misclassification of UP application traffic for another application as being UP application traffic for the Facebook® application.

Alternatively or additionally, the request 36 may request analytics 32 that characterize misclassification of UP application traffic 14 associated with one or more targeted communication devices 12 or one or more targeted groups of communication devices 12, e.g., so that the analytics 32 are specific to only the targeted communication device(s) or group(s). Where for instance different communication devices 12 are identified by respective device identifiers, the request 36 may include one or more device identifiers of the one or more targeted communication devices. Or, where different groups of communication devices 12 are identified by respective group identifiers, the request 36 may include one or more group identifiers of the one or more targeted groups.

As other examples, the request 36 may request analytics 32 that characterize misclassification of UP application traffic 14 associated with one or more targeted data network names (DNNs), one or more targeted network slices of the communication network 10, one or more areas of interest within a geographical coverage area of the communication network 10, and/or one or more access technologies usable for accessing the communication network 10. Alternatively or additionally, the request 36 may indicate a time period over which the analytics 32 are to be generated and/or a confidence level with which the analytics 32 are to be generated. In these and other embodiments, then, the request 36 may specify one or more constraints, filters, or requirements for the analytics 32.

Having received the request 36, the network node 24 generates the analytics 32 according to the request 36, e.g., according to any constraints, filters, or requirements indicated by the request 36. For example, the analytics 32 may indicate, for each of one or more applications 12A, a volume of UP application traffic 14 misclassified for that application and/or a level of confidence that UP application traffic 14 has been misclassified for the application. In some embodiments, the analytics 32 may further indicate, for each of the one or more applications 12A, a model used for classifying UP application traffic 14 for that application, an identity of the application 12A, and/or a list of one or more versions of the application 12A for which the analytics 32 apply. Regardless, the network node 24 transmits these analytics 32 to the consumer node 34 for consumption as described above.

Consider now additional details about how the network node 24 generates the analytics 32 according to some embodiments. In one or more embodiments, the network node 24 generates the analytics 32 based on information obtained from the traffic classifier 22 and/or on information obtained from the communication device(s) 12.

As shown in FIG. 1, for instance, the network node 24 may receive network classification information 40 from the traffic classifier 22, e.g., in response to a request 41 for such information 40. The network classification information 40 characterizes classification of UP application traffic 14 by the communication network 10. For example, the network classification information 40 may comprise, for each of one or more applications 12A, an identifier 40A that identifies the application and descriptive data 40B that describes UP application traffic 14 classified as being traffic of the identified application. The descriptive data 40B for an application may for instance indicate a volume of the UP application traffic classified as traffic of the application, a protocol stack via which that classified UP application traffic was communicated, timing information indicating when that classified UP application traffic was communicated, and/or connection information describing a transport layer connection via which that classified UP application traffic was communicated. Or, in other embodiments not shown, the network classification information 40 may alternatively or additionally comprise a copy of the UP application traffic classified as being traffic of the application, so that the network node 24 itself can evaluate the underlying traffic for determining any desired characteristics of the traffic, such as the UP application traffic volume per application. No matter the particular nature of the network classification information 40, then, the network node 24 can determine or deduce from the network classification information 40 characteristics describing how the communication network 10 has classified UP application traffic, including for instance how much UP application traffic 14 has been classified as relating to each application.

Equipped with the network classification information 40, the network node 24 may use the network classification information 40 to determine an extent to which the communication network 10 is misclassifying UP application traffic 14. The network node 24 may for instance determine this based on recognizing one or more patterns in the network classification information 40, e.g., over time and/or across applications. As on example, the network node 24 may deduce an extent of traffic misclassification based on how the network classification information 40 changes over time. For example, if according to the network classification information 40 the volume of UP application traffic classified as relating to a certain application drops over time by a certain percentage and the volume of UP application traffic classified into a default (match all) application increases by the same or similar percentage, and this pattern does not occur for other applications, the network node 24 may deduce that UP application traffic has been misclassified for that certain application. The network node 24 may deduce this particularly if the same pattern occurs for the certain application across multiple user plane network nodes (not shown). As another example, if according to the network classification information 40 the volume of UP application traffic classified as relating to a certain application changes at the same time as when the protocol stack used for the certain application changes, the network node 24 may deduce that UP application traffic has been misclassified for that certain application. Such protocol stack change may for instance change the ability of the traffic classifier to classify the application's UP application traffic, e.g., such as may occur when the protocol stack change impacts encryption of the UP application traffic. As yet another example, if according to the network classification information 40 the volume of UP application traffic classified as relating to a certain application changes at the same time as when the operating system (or operating system version) executing the certain application changes, the network node 24 may deduce that UP application traffic has been misclassified for that certain application. For instance, updating a communication device's operating system may impact traffic classification due to introducing a higher level of encryption in the UP application traffic, e.g., as may be the case for updating to an operating system with iOS private relay.

Alternatively or additionally, the network node 24 as shown in FIG. 1 may receive device-reported application information 42 from the communication device(s) 12 and determine the extent to which UP application traffic 14 has been misclassified based at least in part on that application information 14. The device-reported application information 42 in this regard characterizes UP application traffic 14 for each of one or more applications at communication device(s) 12. In one embodiment, for example, the device-reported application information 42 indicates, for each of the one or more applications at a communication device 12, an identity of the application 12A as assigned by an operating system of the communication device 12, a version of the application installed on the communication device 12, and/or a volume of UP application traffic 14 communicated for the application. Alternatively or additionally, the device-reported application information 42 may indicate, for each of the one or more applications at the communication device 12, a protocol stack via which UP application traffic 14 for the application was communicated, timing information indicating when UP application traffic 14 for the application was communicated, and/or connection information describing a transport layer connection via which UP application traffic 14 for the application was communicated. No matter the particular nature of the device-reported application information 42, the network node 24 in some embodiments can determine or deduce from the application information 42 characteristics describing how the UP application traffic 14 should be classified by the communication network 10.

Equipped with the device-reported application information 42, the network node 24 may use the device-reported application information 42 to determine an extent to which the communication network 10 is misclassifying UP application traffic 14. The network node 24 may for instance determine the extent of traffic misclassification based on the extent to which the traffic classification suggested by the network classification information 40 differs from what the device-reported application information 42 suggests the traffic classification should be. The network node 24 in this regard may correlate the UP application traffic 14 classified by the communication network 10 with the device-reported application information 40.

In some embodiments, the network node 24 determines the extent of traffic misclassification in these or other ways using a trained machine learning model 44. The trained machine learning model 44 may for instance be trained to identify traffic misclassification upon the occurrence of certain patterns in the classification of UP application traffic 14, e.g., as suggested by the network classification information 40 and/or the device-reported application information 42. The patterns suggestive of traffic misclassification may for instance include patterns across different classification models and/or different application versions. Where the trained machine learning model 44 is based on supervised learning, as an example, the trained machine learning model 44 may be based on regression, decision tree, random forest, k-nearest neighbor, logistic regression, etc.

In one embodiment where the network node 24 uses such a trained machine learning model 44, the network node 24 may also train the machine learning model 44. The network node 24 may for instance obtain network classification information 40 and/or device-reported application information 42 as sample data during a training phase, and train the machine learning model 44 using that information 40, 42.

In some embodiments, the network node 24 retrieves the network classification information 40 and/or the device-reported application information 42 on demand as needed, e.g., in a pull approach. In other embodiments, the network node 24 retrieves the network classification information 40 and/or the device-reported application information 42 upon the occurrence of events at the user plane network node 18 or the communication device (12) that trigger reporting of the information 40, 42. In fact, in some embodiments, the network node 24 subscribes to receive the information 40, 42 upon the occurrence of such events, e.g., in which case the requests 41, 43 in FIG. 1 may be referred to as event subscription requests. In this case, the UP network node 18 and/or the communication device(s) 12 may push the information 40, 42 to the network node 24 upon event occurrence. By making the network classification information 40 and/or the device-reported application information 42 available via such a subscription, then, some embodiments herein ensure the timely delivery of the information 40, 42 and correspondingly timely detection of traffic misclassification, e.g., in real-time.

For example, in some embodiments, the network node 24 transmits the request 41 for the network classification information 40 to the UP network node 18 in the form of an event subscription request 41. This event subscription request requests the UP network node 18 to report the network classification information 40. In one or more embodiments, for instance, the event subscription request 41 includes an event identifier parameter, where different possible values of the event identifier parameter are mapped to different respective types of events. In this case, then, the event identifier parameter included in the event subscription request 41 is set to one of the possible values which is mapped to a type of event that characterizes classification of UP application traffic 14 by the UP network node 18. The event may for instance be triggered upon the UP network node 18 making a traffic classification decision, classifying at least a threshold volume of UP application traffic (e.g., 50 Mbytes), and/or detecting expiration of a timer (e.g., for periodic reporting of the network classification information 40). Alternatively or additionally, the event subscription request 41 may specify one or more constraints, filters, or requirements governing what information is to be reported. For example, in some embodiments, the event subscription request 41 may request the UP network node 18 to report network classification information 40 that characterizes classification of UP application traffic 14 associated with one or more targeted applications 12A, one or more targeted communication devices 12, and/or one or more targeted groups of communication devices 12. In still other embodiments, the event subscription request 41 may request the UP network node 18 to report network classification information 40 that characterizes classification of UP application traffic 14 according to a traffic classification model specified by the event subscription request 41, e.g., so that the reported information is model-specific.

Similarly, in some embodiments, the network node 24 transmits the request 43 for the device-reported application information 42 to communication device(s) 12 in the form of an event subscription request 43. In this case, the event subscription request 43 may request a communication device 12 to report the application information 42. Similarly to the event subscription request 41, in one or more embodiments, the event subscription request 43 includes an event identifier parameter, where different possible values of the event identifier parameter are mapped to different respective types of events. In this case, then, the event identifier parameter included in the event subscription request 43 is set to one of the possible values which is mapped to a type of event that characterizes UP application traffic 14 for each application 12A at a communication device 12. The event may for instance be triggered upon the communication device 12 transmitting and/or receiving at least a threshold volume of UP application traffic. Alternatively or additionally, the event subscription request 43 may specify one or more constraints, filters, or requirements governing what information is to be reported. For example, in some embodiments, the event subscription request 43 may request the communication device(s) 12 to report application information 42 that characterizes UP application traffic 14 for one or more targeted applications 12A. In still other embodiments, the event subscription request 43 may request the communication device(s) 12 to report application information 42 that characterizes UP application traffic 14 according to a traffic classification model specified by the event subscription request 43, e.g., so that the reported information is model-specific.

Consider now one example implementation in a context where the communication network 10 is or evolves from a 5G network. In one example, the network node 26 implements a Network Data Analytics Function (NWDAF) for performing analytics generation as described above. The NWDAF is an operator-managed network analytics logical function, e.g., as specified in 3GPP TS 23.288 v17.2.0. Furthermore, in this and other examples, the UP network node 18 implements a User Plane Function (UPF) for performing UP application traffic handling as described above. The UPF in this regard may handle UP application traffic based on rules received from a Session Management Function (SMF), e.g., packet inspection and different enforcement actions such as QoS handling. Note that the NWDAF may either be a central NDWAF or might be co-located with the UPF. The consumer node 34 may take the form of an Operations, Administration, and Maintenance (OAM) node, another NWDAF, or any other Network Function (NF) in the communication network 10. In one example, the UP application traffic 14 is transported in an encrypted form, e.g., using HyperText Transfer Protocol Secure (HTTPS) or the QUIC protocol. Some embodiments in this context define a new type of analytic relative to traffic misclassification, which allows a mobile network operator (MNO) to automate the process for detecting misclassification for UP traffic. In fact, some embodiments in this regard advantageously allow the MNO to determine, in an automated way and in real time, which applications are being misclassified.

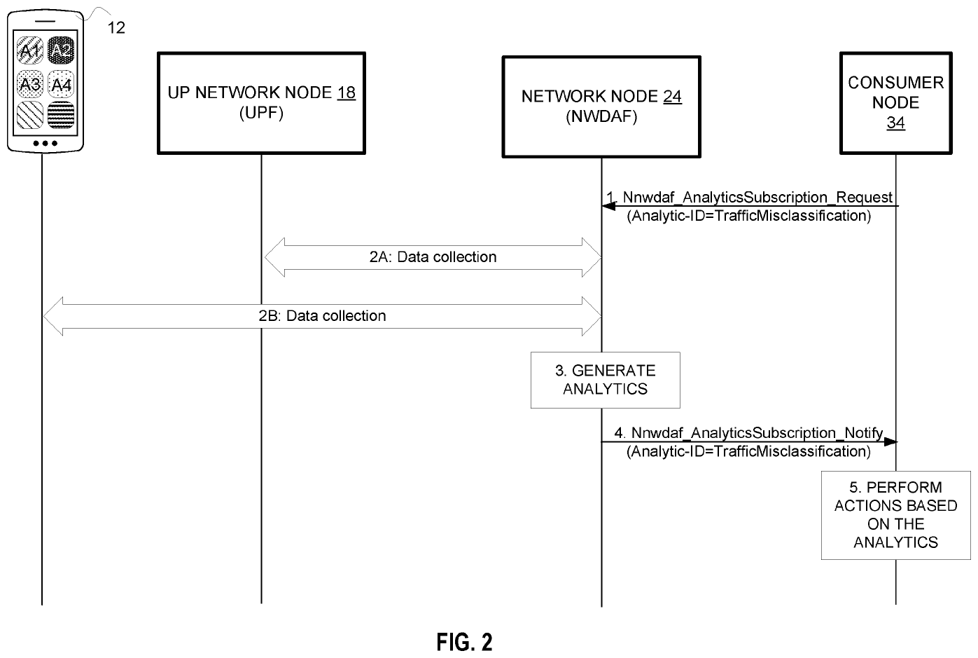

FIG. 2 shows one example implementation according to some embodiments. In this example, the consumer node 34 subscribes to the NWDAF for obtaining the new traffic misclassification analytic. As shown in FIG. 2, the consumer node 34 in this regard transmits a Nnwdaf_AnalyticsSubscription_Request message to the NWDAF including an Analytic-ID parameter set to a value of ‘TrafficMisclassification’ (Step 1). The Nnwdaf_AnalyticsSubscription_Request message thereby exemplifies the request 36 herein and may also include one or more of the following parameters. One parameter may be a list of one or more App-IDs. This list indicates the App-ID(s) which are the target for traffic misclassification analytics. When not present, any App-ID applies. Another parameter may be a UE-ID or a list of one or more UE-IDs, a UE-Group-ID or a list of one or more UE-Group-IDs, or an AnyUE parameter. This indicates the UE(s) which are the target for traffic misclassification analytics. When not present, AnyUE applies. Yet another parameter may include a TimePeriod parameter. This indicates the period for which the analytic applies, e.g., daily, weekly, monthly. Still another parameter may be a confidence level parameter, e.g., indicating the required confidence level from the consumer node 34. Still other parameter(s) may indicate filter information, e.g., on the basis of Data Network Name (DNN), Single Network Slice Selection Assistance Information (S-NSSAI), Area of Interest, Radio Access Technology (RAT) Type, etc.

Based on the analytics subscription request in Step 1, the NWDAF triggers collection of data from the UPF (Step 2A), as an example of the network classification information 40 and, optionally, collection of data from one or more communication devices (e.g., in the form of one or more user equipment, UE) (Step 2B), as an example of device-reported application information 42. The data collection from the UPF may include data regarding traffic classification on a per App-ID basis. Alternatively, data collection from the UPF may include data regarding mirrored data (i.e. raw packets). The data collection from the UE(s) may include data regarding the active applications at the UE(s), e.g., from the perspective of the Operating System (OS).

Based on the data collected in Steps 2A and 2B, the NWDAF runs analytic processes and generates the analytics 32 (Step 3). In some embodiments, the analytics 32 include a TrafficMisclassification parameter set to a value of YES or NO. If NO, it means there is no misclassification for any App-ID in the list of App-IDs, e.g., if this is analytic is reported daily, it means that for this daily report, the analytic result indicates there is no misclassification. If YES, it means that there is misclassification for at least one App-ID in the list of App-IDs. In this case where the TrafficMisclassification parameter has a value of YES, the analytics further include one or more the following parameters. One parameter is a list of App-ID(s), e.g., as a subset of the List of App-ID in the subscription request, which indicates for which App-IDs traffic misclassification has been detected. Another parameter, optionally includes a List of UE-ID(s), e.g., as a subset of the List of UE-ID in the subscription request, which indicates for which UE-IDs traffic misclassification has been detected. For each App-ID in the above list, the analytics 32 may include one or more of: (i) Confidence metric (%), which indicates the confidence that traffic misclassification has happened (e.g. 90% sure there is misclassification for App-ID=Facebook); (ii) % of volume misclassified (e.g. 30% Facebook traffic has been misclassified); (iii) TrafficClassificationModel, e.g., indicating the reason for misclassification is potentially a non-up-to-date traffic classification model; and/or (iv) OSAppId and version, e.g., indicating the reason for misclassification is potentially a new app version.

Having generated the analytics 32, the NWDAF transmits the analytics 32 to the consumer node 34 in accordance with the subscription request (Step 4). As shown, the NWDAF may do so by transmitting a Nnwdaf_AnalyticsSubscription_Notify message that includes the analytics 32 and identifies the included analytics 32 as concerning traffic misclassification by setting an Analytic-ID parameter set to a value of ‘TrafficMisclassification’.

The consumer node 34 may then perform action(s) based on the received analytics 32 (Step 5). For example, in case there is traffic misclassification for a certain App-ID, the consumer node 34 may trigger the process to retrain a machine learning model for traffic classification for the corresponding App-Id(s), trigger an alarm or warning, increase a counter to account for traffic misclassification events, and/or charge App-ID volume into a specified rating group (RG).

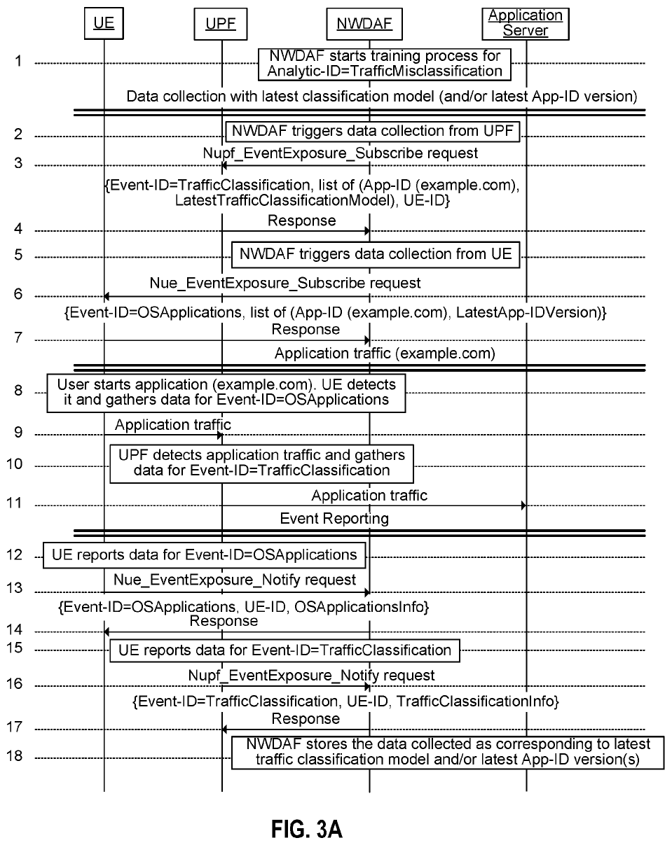

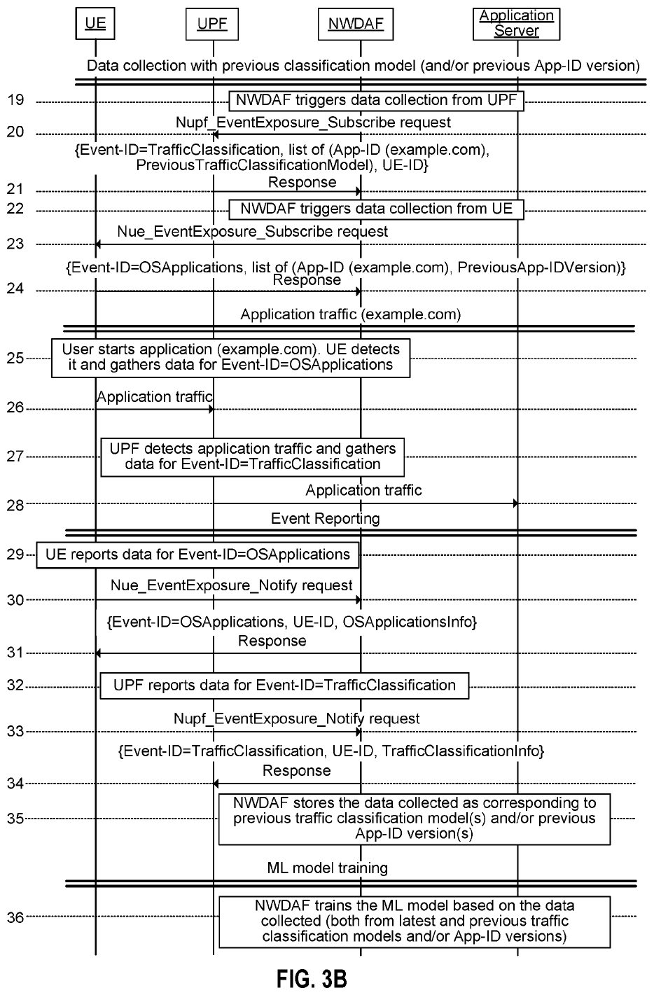

FIGS. 3A-3B show additional details of a process for training the machine learning model 44 for recognizing traffic misclassification according to some embodiments, e.g., where the machine learning model training process is supervised.

As shown in Steps 1 and 2, the NWDAF starts the training process for Analytic-ID=TrafficMisclassification. This can be triggered by the consumer node 34, e.g., which requests the NWDAF to trigger the training process relative to Analytic-ID=TrafficMisclassification. For example, in some embodiments, the consumer node 34 may trigger towards the NWDAF a Nnwdaf_Training_Subscribe request message including the following parameters: (i) Analytic-ID=TrafficMisclassification; (ii) List of App-ID(s) indicating the App-ID(s) which are the target for traffic misclassification analytics (when not present, any App-ID applies); (iii) UE-ID or list of UE-ID, UE-Group-ID or list of UE-Group-ID, or AnyUE, indicating the UE(s) which are the target for traffic misclassification analytics (when not present, AnyUE applies); and/or (iv) other filter information like DNN, S-NSSAI or Area of Interest.

The NWDAF then performs data collection with the latest classification model (and/or latest App-ID version) in Steps 2-18, as well as data collection with the previous classification model (and/or previous App-ID version) in Steps 19-35.

With regard to data collection with the latest classification model, in Steps 2 and 3, the NWDAF triggers data collection from the UPF, specifically to retrieve information relative to traffic classification for UE-ID. In order to do this, the NWDAF triggers a Nupf_EventExposure_Subscribe request message including the following parameters: (i) Event-ID=TrafficClassification; (ii) UE-ID indicating the target UE(s) for this event; and (iii) list of (App-ID, LatestTrafficClassificationModel). Here, App-ID indicates the App-ID/s for which traffic classification is required. The default App-ID is also considered. LatestTrafficClassificationModel this indicates that the UPF is to use the latest traffic classification model to classify traffic for App-ID. In some embodiments, the NWDAF may trigger data collection from the UPF directly (e.g., where the UPF is service-based) or indirectly through the SMF, e.g., as described in 3GPP TR 23.700-91. Regardless, in Step 4, the UPF answers the request message in Step 3 with a successful response (accepting the request).

In Steps 5 and 6, optionally, the NWDAF triggers data collection from the UE, specifically to retrieve information relative to (OS) applications for UE-ID. In order to do this, NWDAF triggers a Nue_EventExposure_Subscribe request message including the following parameters: (i) Event-ID=OSApplications and (ii) list of (App-ID, LatestApp-IDVersion). Here, App-ID this indicates the App-ID/s for which OSApplications event applies to. LatestApp-IDVersion indicates that the UE is to report the event only if the requested App-IDVersion is installed at the UE for the App-ID. Step 7) UE answers the request message in Step 6 with a successful response (accepting the request). In Step 8, the User starts an application (example.com). The UE detects the request from the application client and gathers data for Event-ID=OSApplications. In particular, the UE stores the following information: OSApplication-ID (example.com), OSApp-IDVersion, and, for each flow: (i) Timestamp (indicating the start time for the flow), (ii) 5-tuple, and (iii) Volume. Note that, when the list of App-ID is included in the message in Step 6, the UE filters based on that list.

In Step 9, the UE sends the UP application traffic (example.com). In Steps 10 and 11, the UPF detects the UP application traffic (example.com) and gathers data for Event-ID=TrafficClassification. The UPF in some embodiments stores the following information: App-ID (example.com), TrafficClassificationModel for App-ID, and, for each detected flow: (i) Timestamp (indicating the start and stop time for the flow) and duration; (ii) 5-tuple; (iii) volume (in bytes and/or packets) and optionally differentiating uplink and downlink volume; (iv) Number of packets and average packet size; and (v) ProtocolStack (e.g. HTTP3/QUIC/UDP/IP, HTTP2/TLS/TCP/IP).

In steps 12 and 13, the UE continues gathering data for Event-ID=OSApplications and at some point (e.g. periodic reporting), UE reports data for Event-ID=OSApplications. In order to do that, the UE notifies the NWDAF by triggering a Nue_EventExposure_Notify request message. The message may include the following parameters: (i) Event-ID=OSApplications, (ii) UE-ID, (iii) OS-ID (e.g. IOS, Android); and (iv) OSApplicationsInfo. In one embodiment, OSApplicationsInfo includes the following information (stored in previous steps): (i) OSApplication-ID (example.com); (ii) OSApp-IDVersion; and (iii) for each flow, timestamp (indicating the start time for the flow), 5-tuple, and volume (optionally differentiating uplink and downlink volume).

In Step 14, the NWDAF answers the message in Step 13 indicating successful operation. In Steps 15 and 16, the UPF continues gathering data for Event-ID=TrafficClassification and at some point (e.g. periodic reporting), UPF reports data for Event-ID=TrafficClassification. In order to do that, UPF notifies NWDAF by triggering Nupf_EventExposure_Notify request message including the following parameters: Event-ID=TrafficClassification, UE-ID, and TrafficClassificationInfo. In one embodiment, TrafficClassificationInfo includes the following information: App-ID (example.com), TrafficClassificationModel for App-ID, and, for each detected flow: (i) Timestamp (indicating the start and stop time for the flow) and duration, (ii) 5-tuple, (iii) Volume (in bytes and/or packets) and optionally differentiating uplink and downlink volume, (iv) Number of packets and average packet size, and (v) ProtocolStack (e.g. HTTP3/QUIC/UDP/IP, HTTP2/TLS/TCP/IP). In Step 17, the NWDAF answers the message in Step 16 with a successful response. In Step 18, the NWDAF stores the data collected as corresponding to latest traffic classification model and/or latest App-ID version/s.

In Steps 19 and 20, the NWDAF triggers data collection from the UPF, specifically to retrieve information relative to traffic classification for UE-ID. In order to do this, the NWDAF triggers a Nupf_EventExposure_Subscribe request message including the following parameters: Event-ID=TrafficClassification; list of (App-ID, Previous TrafficClassificationModel); and UE-ID. The UE-ID indicates the target UE/s for this event. In one embodiment, the list of (App-ID, Previous TrafficClassificationModel) includes the following information: (i) App-ID, which indicates the App-ID/s for which traffic classification is required, with the default App-ID also being considered; and (ii) Previous TrafficClassificationModel, which indicates to the UPF to use a previous traffic classification model to classify traffic for App-ID.

In some embodiments, the NWDAF may trigger data collection from the UPF directly (e.g., where the UPF is service-based) or indirectly through the SMF, e.g., as described in 3GPP TR 23.700-91.

In Step 21, the UPF answers the request message in Step 20 with a successful response (accepting the request).

In Steps 22 and 23, optionally, the NWDAF triggers data collection from the UE, specifically to retrieve information relative to (OS) applications for UE-ID. In order to do this, the NWDAF triggers a Nue_EventExposure_Subscribe request message including the following parameters: Event-ID=OSApplications; and list of (App-ID, PreviousApp-IDVersion). In one embodiment, the list of (App-ID, PreviousApp-IDVersion) includes the following information: (i) App-ID, which indicates the App-ID/s for which OSApplications event applies to; and (ii) optionally, PreviousApp-IDVersion, which indicates to the UE to report the event only if the requested App-IDVersion is installed at the UE for the App-ID.

In some embodiments, the NWDAF may trigger data collection from the UE as described in 3GPP TR 23.700-91.

In Step 24, the UE answers the request message in Step 23 with a successful response (accepting the request).

In Step 25, the user starts an application (example.com). The UE detects the request from the application client and gathers data for Event-ID-OSApplications. In particular, the UE stores the following information: OSApplication-ID (example.com); OSApp-IDVersion; and for each flow: (i) Timestamp (indicating the start time for the flow); (ii) 5-tuple; and Volume. When list of App-ID is included in the message in Step 23, the UE filters based on that list. In Step 26, the UE sends application traffic (example.com).

In Steps 27 and 28, the UPF detects application traffic (example.com) and gathers data for Event-ID=TrafficClassification. The UPF stores the following information: App-ID (example.com), TrafficClassificationModel for App-ID, and for each detected flow: (i) Timestamp (indicating the start and stop time for the flow) and duration; (ii) 5-tuple; (iii) Volume (in bytes and/or packets) and optionally differentiating uplink and downlink volume; (iv) Number of packets and average packet size; and (v) ProtocolStack (e.g. HTTP3/QUIC/UDP/IP, HTTP2/TLS/TCP/IP).

In Steps 29 and 30, the UE continues gathering data for Event-ID=OSApplications and at some point (e.g., periodic reporting), the UE reports data for Event-ID=OSApplications. In order to do that, the UE notifies the NWDAF by triggering a Nue_EventExposure_Notify request message including the following parameters: Event-ID=OSApplications, UE-ID, OS-ID (e.g. IoS, Android); OSApplicationsInfo, which includes the following information (stored in previous steps): (i) OSApplication-ID (example.com); (ii) OSApp-IDVersion; and (iii) for each flow: Timestamp (indicating the start time for the flow), 5-tuple, and Volume (optionally differentiating uplink and downlink volume).

In Step 31, the NWDAF answers the message in Step 30 indicating successful operation.

In Steps 32 and 33, the UPF continues gathering data for Event-ID=TrafficClassification and at some point (e.g., periodic reporting) the UPF reports data for Event-ID=TrafficClassification. In order to do that, the UPF notifies the NWDAF by triggering Nupf_EventExposure_Notify request message including the following parameters: Event-ID=TrafficClassification; UE-ID; and TrafficClassificationInfo. In one embodiment, TrafficClassificationInfoincludes the following information: (i) App-ID (example.com); (ii) TrafficClassificationModel for App-ID; and (iii) for each detected flow: Timestamp (indicating the start and stop time for the flow) and duration, 5-tuple, Volume (in bytes and/or packets) and optionally differentiating uplink and downlink volume, Number of packets and average packet size, and ProtocolStack (e.g. HTTP3/QUIC/UDP/IP, HTTP2/TLS/TCP/IP)

In Step 34, the NWDAF answers the message in Step 33 with a successful response. In Step 35, the NWDAF stores the data collected as corresponding to previous traffic classification model and/or previous App-ID version/s.

In Step 36, the NWDAF trains the machine learning (ML) model for traffic misclassification based on the data collected (both from latest and previous traffic classification models and/or App-ID versions). For example, the NWDAF might identify patterns as follows: (i) by comparing data collected corresponding to the latest traffic classification model and/or latest App-ID version, and, data collected corresponding to the previous traffic classification model and/or previous App-ID version. UPF detects that a certain application detection decreases while the overall traffic patterns remain unchanged; (ii) if the data volume classified into a certain App-ID (example.com) drops by a certain percentage and the data volume classified into the default (match-all) App-ID goes up by a same/similar percentage, and this pattern does not happen for the other App-IDs, and if this pattern is repeated for any (sampled) UE-ID session in all UPFs, this can be identified by the NWDAF as a pattern for traffic misclassification. The above is just an example. Other patterns might be identified by NWDAF, e.g., by reporting the protocol stack information for a certain App-ID, the NWDAF might identify if traffic misclassification is due to encryption (e.g., when App-ID=Facebook moves from an IP/TCP/TLS/HTTP to UDP/QUIC protocol stack). Another pattern might be dependencies with the OS-ID (IOS, Android).

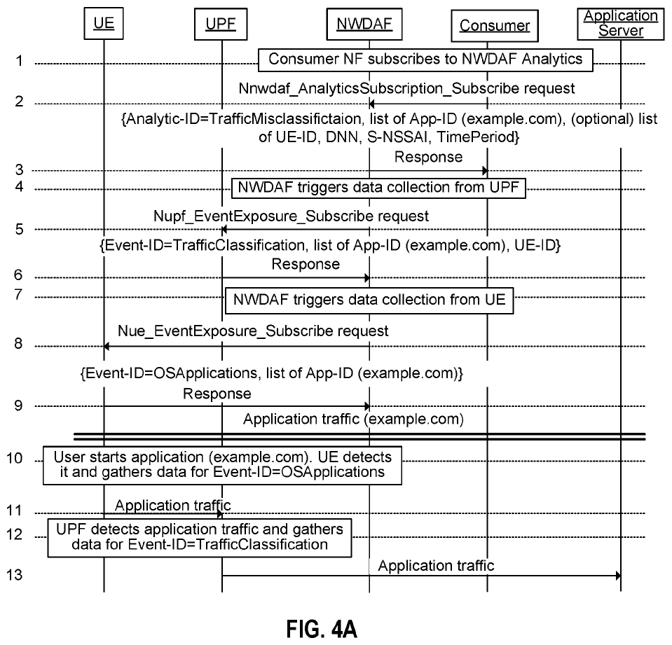

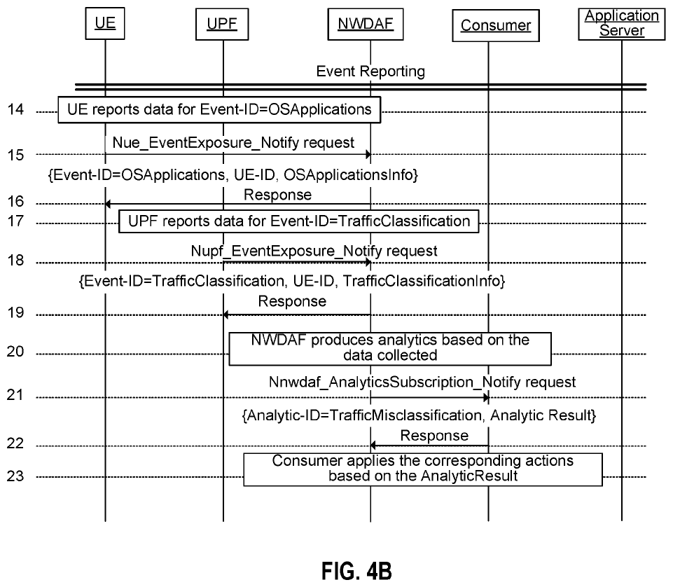

FIGS. 4A-4B show a sequence diagram describing embodiments where data collection from the UPF is relative to traffic classification. Steps are detailed below:

In Steps 1 and 2, the consumer node 34 subscribes to the NWDAF related to a new analytic, Analytic-ID=TrafficMisclassification). The consumer node 34 does so by triggering a Nnwdaf_AnalyticsSubscription_Subscribe request message, as an example of the request 36 herein. The Nnwdaf_AnalyticsSubscription_Subscribe request message includes the following parameters: (i) Analytic-ID=TrafficMisclassification; (ii) list of App-ID, which indicates the App-ID/s which are the target for traffic misclassification analytics (when not present, any App-ID applies); (iii) UE-ID or list of UE-ID, UE-Group-ID or list of UE-Group-ID, AnyUE, which indicates the UE/s which are the target for traffic misclassification analytics (when not present, AnyUE applies); (iv) other filter information like DNN, S-NSSAI or Area of Interest; and (v) TimePeriod (e.g. daily, weekly, monthly), which indicates the period for which the analytic applies.

In Step 3, the NWDAF answers the request message in Step 2 with a successful response (accepting the request).

In Steps 4 and 5, the NWDAF triggers data collection from the UPF, specifically to retrieve information relative to traffic classification for UE-ID. In order to do this, the NWDAF triggers a Nupf_EventExposure_Subscribe request message including the following parameters: (i) Event-ID=TrafficClassification; (ii) list of App-ID, which indicates the App-ID/s for which traffic classification is required (the default App-ID is also considered); and (iii) UE-ID, which indicates the target UE/s for this event.

In Step 6, the UPF answers the request message in Step 5 with a successful response (accepting the request).

In Steps 7 and 8, optionally, the NWDAF triggers data collection from the UE, specifically to retrieve information relative to (OS) applications for UE-ID. In order to do this, the NWDAF triggers a Nue_EventExposure_Subscribe request message including the following parameters: (i) Event-ID=OSApplications; and (ii) list of App-ID: this indicates the App-ID/s for which OSApplications event applies to.

In Step 9, the UE answers the request message in Step 8 with a successful response (accepting the request).

In Step 10, the user starts an application (example.com). The UE detects the request from the application client and gathers data for Event-ID=OSApplications. In particular, the UE stores the following information: OSApplication-ID (example.com); OSApp-IDVersion; and for each flow: (i) Timestamp (indicating the start time for the flow); (ii) 5-tuple; and (iii) Volume. When list of App-ID is included in the message in Step 8, the UE filters based on that list.

In Step 11, the UE sends application traffic (example.com).

In Steps 12 and 13, the UPF detects application traffic (example.com) and gathers data for Event-ID=TrafficClassification. The UPF stores the following information: App-ID (example.com); TrafficClassificationModel for App-ID; and for each detected flow: (i) Timestamp (indicating the start and stop time for the flow) and duration; (ii) 5-tuple; (iii) Volume (in bytes and/or packets) and optionally differentiating uplink and downlink volume; (iv) Number of packets and average packet size; and (v) ProtocolStack (e.g. HTTP3/QUIC/UDP/IP, HTTP2/TLS/TCP/IP).

In Steps 14 and 15, the UE continues gathering data for Event-ID=OSApplications and at some point (e.g. periodic reporting) the UE reports data for Event-ID=OSApplications. In order to do that, the UE notifies the NWDAF by triggering a Nue_EventExposure_Notify request message including the following parameters: Event-ID=OSApplications; UE-ID; OS-ID (e.g. IoS, Android); OSApplicationsInfo, which includes the following information (stored in previous steps): (i) OSApplication-ID (example.com); (ii) OSApp-IDVersion; and (iii) for each flow: Timestamp (indicating the start time for the flow), 5-tuple, and volume (optionally differentiating uplink and downlink volume)

In Step 16, the NWDAF answers the message in Step 15 indicating successful operation.

In Steps 17 and 18, the UPF continues gathering data for Event-ID=TrafficClassification and at some point (e.g. periodic reporting) the UPF reports data for Event-ID=TrafficClassification, as an example of network classification information 40 herein. In order to do that, the UPF notifies the NWDAF by triggering Nupf_EventExposure_Notify request message including the following parameters: Event-ID=TrafficClassification; UE-ID; and TrafficClassificationInfo. In one embodiment, TrafficClassificationInfo includes the following information: (i) App-ID (example.com); (ii) TrafficClassificationModel for App-ID; and (iii) for each detected flow: Timestamp (indicating the start and stop time for the flow) and duration; 5-tuple; Volume (in bytes and/or packets) and optionally differentiating uplink and downlink volume; Number of packets and average packet size; and ProtocolStack (e.g. HTTP3/QUIC/UDP/IP, HTTP2/TLS/TCP/IP).

In Step 19, the NWDAF answers the message in Step 18 with a successful response.

In Step 20, the NWDAF produces analytics 32 based on the data collected from UPF and UE. To detect Traffic Misclassification, the NWDAF uses a Machine Learning model (obtained through the training process described in FIGS. 3A-3B). Based on this, the NWDAF determines if Traffic Misclassification is happening or not, and stores the following information, as an example of analytics 32: (i) List of App-IDs, which Identifies the App-IDs from which traffic misclassification has been detected; (ii) Optionally, a List of UE-ID (as a subset of the List of UE-ID in the subscription), which indicates for which UE-IDs traffic misclassification has been detected; and (iii) for each App-ID in the above list: Confidence metric (%), which indicates the confidence that traffic misclassification has happened (e.g., 90% sure there is misclassification for App-ID=Facebook); % of volume misclassified (e.g., 30% Facebook traffic has been misclassified); optionally, TrafficClassificationModel (this might indicate the reason for misclassification is potentially a non-up-to-date traffic classification model); and optionally, OSAppId and version (this might indicate the reason for misclassification is potentially a new app version).

In Step 21, based on the above, the NWDAF notifies the consumer node 34 by triggering a Nnwdaf_AnalyticsSubscription_Notify request message including the following parameters: Analytic-ID=TrafficMisclassification; and (ii) AnalyticResult. In one embodiment, AnalyticResult includes the following information (stored in Step 20 above): TrafficMisclassification=YES/NO. If NO, it means there is no misclassification for any App-ID in the list of App-IDs (e.g. if this is analytic is reported daily, it means that for this daily report, the analytic result indicates there is no misclassification). If YES: it means that there is misclassification for at least one App-ID in the list of App-IDs. In this case, the analytics result may include the following parameters: (i) List of App-ID (as a subset of the List of App-ID in the subscription), which indicates for which App-IDs traffic misclassification has been detected; (ii) optionally, List of UE-ID (as a subset of the List of UE-ID in the subscription), which indicates for which UE-IDs traffic misclassification has been detected; and (iii) for each App-ID in the above list: Confidence metric (%), which indicates the confidence that traffic misclassification has happened (e.g. 90% sure there is misclassification for App-ID=Facebook); % of volume misclassified (e.g. 30% Facebook traffic has been misclassified); optionally, TrafficClassificationModel (this might indicate the reason for misclassification is potentially a non-up-to-date traffic classification model); and optionally, OSAppId and version (this might indicate the reason for misclassification is potentially a new app version).

In Step 22, the consumer node 34 answers the message in Step 21 with a successful response.

In Step 23, the consumer node 34 applies the corresponding actions based on the AnalyticResult. In case there is traffic misclassification for a certain App-ID, the consumer node may: (i) Trigger the process to retrain the ML model for traffic classification for the corresponding App-ID/s; (ii) Trigger an alarm/warning (FM); (iii) Increase a counter to account for traffic misclassification events (PM); and/or (iv) Charge App-ID volume into a specific RG, etc.

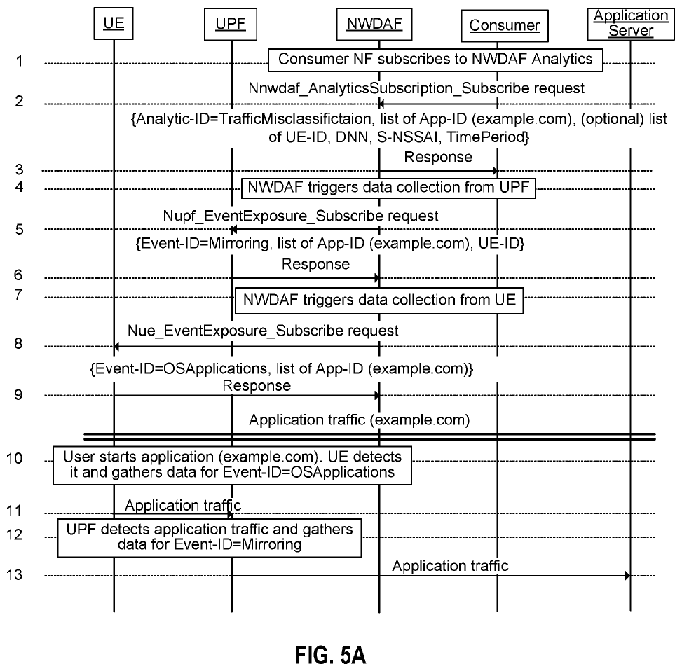

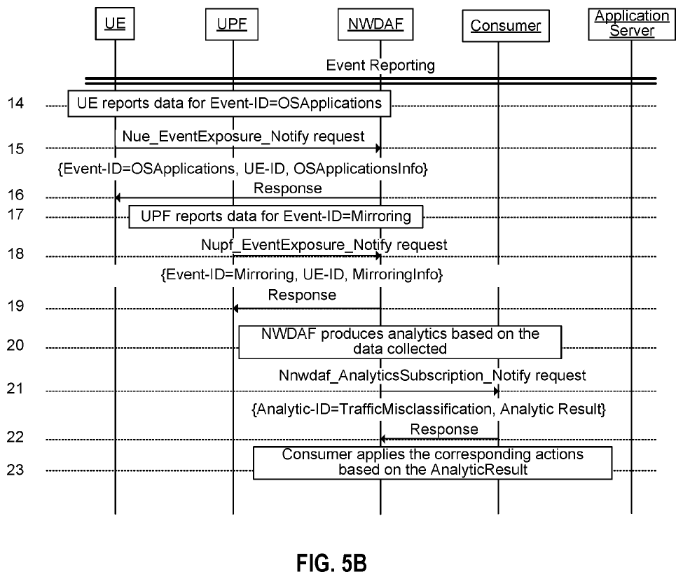

FIGS. 5A-5B by contrast show a traffic Misclassification detection mechanism where data collection from UPF is relative to mirrored data. The steps are the same as in FIGS. 4A-4B, except as described below.

In Steps 4 and 5, the NWDAF triggers data collection from UPF, specifically to retrieve mirrored data (i.e. raw IP packets) for UE-ID. In order to do this, the NWDAF triggers a Nupf_EventExposure_Subscribe request message including the following parameters: Event-ID=Mirroring: (Optional) list of App-ID which indicates the App-ID/s for which mirrored data is required; and UE-ID indicating the target UE/s for this event.

In Steps 12 and 13, the UPF detects application traffic, generates a duplicate for each packet and stores it for Event-ID=Mirroring. The UPF for example stores the following information, as another example of network classification information 40: App-ID (example.com), TrafficClassificationModel for App-ID, and, for each detected flow: Timestamp (indicating the start and stop time for the flow) and duration as well as raw IP packets for the whole flow.

In Steps 17 and 18, the UPF continues gathering data for Event-ID=Mirroring and at some point (e.g. periodic reporting) the UPF reports data for Event-ID=Mirroring. In order to do that, the UE notifies the NWDAF by triggering Nupf_EventExposure_Notify request message including the following parameters: (i) Event-ID=Mirroring; (ii) UE-ID; and (iii) MirroringInfo. The MirroringInfo may include the following information: App-ID (example.com), TrafficClassificationModel for App-ID, and, for each detected flow: Timestamp (indicating the start and stop time for the flow) and duration as well raw IP packets for the whole flow.

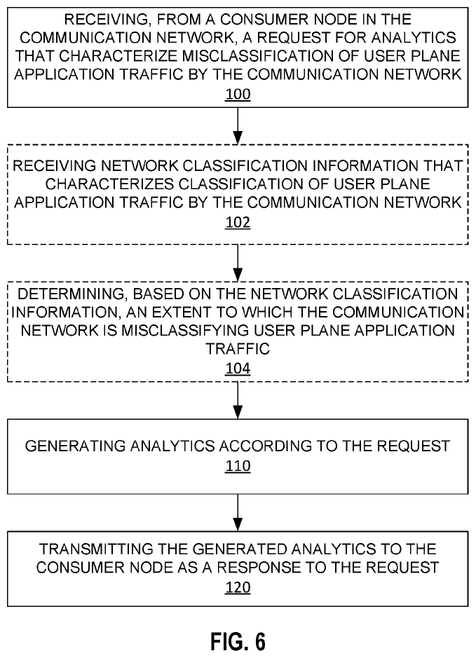

In view of the modifications and variations herein, FIG. 6 depicts a method performed by the network node 24 in the communication network 10 in accordance with particular embodiments. The method comprises receiving, from a consumer node 34 in the communication network 10, a request 36 for analytics 32 that characterize misclassification of user plane application traffic 14 by the communication network 10 (Block 100). The method further comprises generating analytics 32 according to the request 36 (Block 110). The method also comprises transmitting the generated analytics 32 to the consumer node 34 as a response to the request 36 (Block 120).

In some embodiments, the method further comprises receiving network classification information 40 that characterizes classification of user plane application traffic 14 by the communication network 10 (Block 102). The method in this case may also comprise determining, based on the network classification information 40, an extent to which the communication network 10 is misclassifying user plane application traffic 14 (Block 104). In this case, the analytics 32 are generated based on the determined extent. In one or more of these embodiments, network classification information 40 comprises, for each of one or more applications, an identifier that identifies the application 12A, and a copy of user plane application traffic 14 classified as being traffic of the identified application and/or descriptive data that describes the user plane application traffic 14 classified as being traffic of the identified application.

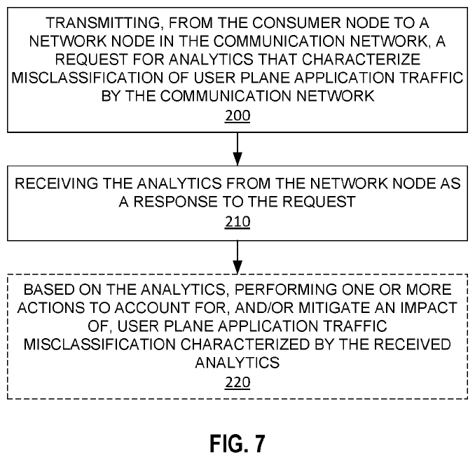

FIG. 7 depicts a method performed by the consumer node 34 in the communication network 10 in accordance with other particular embodiments. The method comprises transmitting, from the consumer node 34 to a network node 24 in the communication network 10, a request 36 for analytics that characterize misclassification of user plane application traffic 14 by the communication network 10 (Block 200). The method further comprises receiving the analytics 32 from the network node 24 as a response to the request 36 (Block 210).

In some embodiments, the method further comprises, based on the analytics 32, performing one or more actions to account for, and/or mitigate an impact of, user plane application traffic misclassification characterized by the received analytics 32 (Block 220). In one or more of these embodiments, the one or more actions include one or more of triggering re-training of a machine learning model that governs user plane application traffic classification 14 by the communication network 10, triggering an alarm or warning indicating occurrence of misclassification of user plane application traffic 14 by the communication network 10, increasing a counter indicating a number of occurrences of misclassification of user plane application traffic 14 by the communication network 10, or adjusting charging to account for misclassification of user plane application traffic 14 by the communication network 10.

In any of the embodiments for the method in FIG. 6 or FIG. 7, the request 36 may include an analytic identifier parameter. In this case, different possible values of the analytic identifier parameter are mapped to different respective types of analytics, and the analytic identifier parameter included in the request is set to one of the possible values which is mapped to a type of analytics that characterizes misclassification of user plane application traffic 14 by the communication network 10.

Alternatively or additionally, In any of the embodiments for the method in FIG. 6 or FIG. 7, the request 36 may comprise a request for analytics that characterize misclassification of user plane application traffic 14 associated with one or more targeted applications, and/or one or more targeted communication devices or one or more targeted groups of communication devices, and/or one or more targeted data network names, and/or one or more targeted network slices of the communication network 10, and/or one or more areas of interest within a geographical coverage area of the communication network 10, and/or one or more access technologies usable for accessing the communication network 10.

In some embodiments, the analytics 32 indicate an extent to which the communication network 10 has misclassified user plane application traffic 14, and/or for which one or more applications and/or for which one or more communication devices user plane application traffic has been misclassified.

In some embodiments, the analytics 32 indicate, for each of one or more applications a volume of user plane application traffic 14 misclassified for that application, and/or a level of confidence that user plane application traffic 14 has been misclassified for the application. In one or more of these embodiments, the analytics 32 further indicate, for each of the one or more applications, a model used for classifying user plane application traffic for that application, and/or an identity of the application, and/or a list of one or more versions of the application for which the generated analytics 32 apply.

In some embodiments, misclassification of user plane application traffic 14 by the communication network 10 comprises misclassification of user plane application traffic 14 for one application as being user plane application traffic 14 for another application.

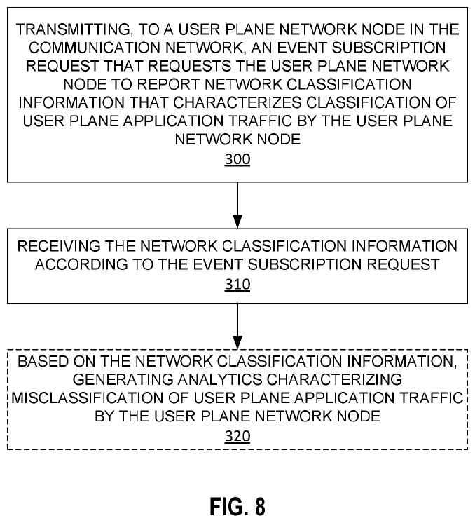

FIG. 8 shows other embodiments herein for a method performed by the network node 24 in the communication network 10. The method comprises transmitting, to a user plane network node 18 in the communication network 10, an event subscription request 41 that requests the user plane network node 18 to report network classification information 40 that characterizes classification of user plane application traffic 14 by the user plane network node 18 (Block 300). The method further comprises receiving the network classification information 40 according to the event subscription request 41 (Block 310).

In some embodiments, the method further comprises, based on the network classification information 40, generating analytics 32 characterizing misclassification of user plane application traffic 14 by the user plane network node 18 (Block 320).

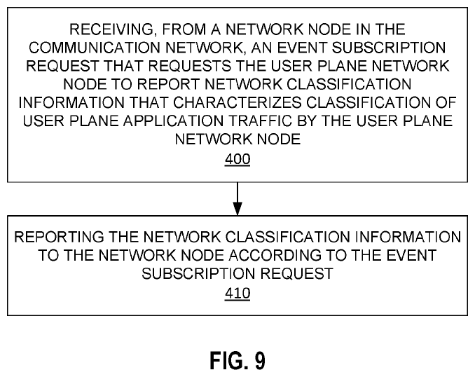

FIG. 9 shows still other embodiments herein for a method performed by a user plane network node 18 in a communication network 10. The method comprises receiving, from a network node 24 in the communication network 10, an event subscription request 41 that requests the user plane network node 18 to report network classification information 40 that characterizes classification of user plane application traffic 14 by the user plane network node 18 (Block 400). The method further comprises reporting the network classification information 40 to the network node 24 according to the event subscription request 41 (Block 410).

In some embodiments of the method in FIG. 8 and/or FIG. 9, the event subscription request 41 includes an event identifier parameter. In this case, different possible values of the event identifier parameter are mapped to different respective types of events, and the event identifier parameter included in the event subscription request is set to one of the possible values which is mapped to a type of event that characterizes classification of user plane application traffic 14 by the user plane network node 18.

In some embodiments, the event subscription request 41 alternatively or additionally requests the user plane network node 18 to report network classification information 40 that characterizes classification of user plane application traffic 14 associated with, and/or one or more targeted communication devices or one or more targeted groups of communication devices.

Alternatively or additionally, in some embodiments, the event subscription request 41 requests the user plane network node 18 to report network classification information 40 that characterizes classification of user plane application traffic 14 according to a traffic classification model specified by the event subscription request 41.

In some embodiments of the method in FIG. 8 and/or FIG. 9, the network classification information 40 comprises, for each of one or more applications, an identifier that identifies the application, and a copy of user plane application traffic 14 classified as being traffic of the identified application and/or descriptive data that describes the user plane application traffic 14 classified as being traffic of the identified application.

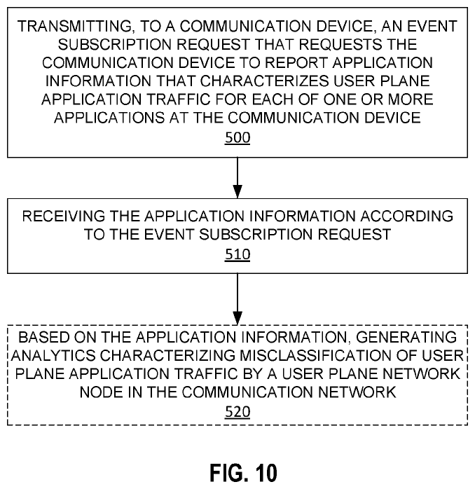

FIG. 10 shows other embodiments herein that include a method performed by a network node 24 in a communication network 10. The method comprises transmitting, to a communication device 12, an event subscription request 43 that requests the communication device 12 to report application information 42 that characterizes user plane application traffic 14 for each of one or more applications 12A at the communication device 12 (Block 500). The method further comprises receiving the application information 42 according to the event subscription request 41 (Block 510).

In some embodiments, the method further comprises, based on the application information 42, generating analytics 32 characterizing misclassification of user plane application traffic 14 by a user plane network node 18 in the communication network 10 (Block 520).

FIG. 11 shows other embodiments herein for a method performed by a communication device 12. The method comprises receiving, from a network node 24 in a communication network 10, an event subscription request 41 that requests the communication device 12 to report application information 42 that characterizes user plane application traffic 14 for each of one or more applications 12A at the communication device 12 (Block 600). The method further comprises transmitting the application information 42 to the network node 24 according to the event subscription request 43 (Block 610).

In some embodiments of the method in FIGS. 10 and/or FIG. 11, the application information 42 indicates, for each of the one or more applications 12A at the communication device 12, an identity of the application as assigned by an operating system of the communication device 12 and/or a version of the application installed on the communication device 12, and a volume of user plane application traffic 14 communicated for the application.

In some embodiments, the application information 42 alternatively or additionally indicates, for each of the one or more applications at the communication device 12, a protocol stack via which user plane application traffic 14 for the application was communicated, and/or timing information indicating when user plane application traffic 14 for the application was communicated, and/or connection information describing a transport layer connection via which user plane application traffic 14 for the application was communicated.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 24 configured to perform any of the steps of any of the embodiments described above for the network node 24.

Embodiments also include a network node 24 comprising processing circuitry and power supply circuitry. The processing circuitry is configured to perform any of the steps of any of the embodiments described above for the network node 24. The power supply circuitry is configured to supply power to the network node 24.

Embodiments further include a network node 24 comprising processing circuitry. The processing circuitry is configured to perform any of the steps of any of the embodiments described above for the network node 24. In some embodiments, the network node 24 further comprises communication circuitry.

Embodiments further include a network node 24 comprising processing circuitry and memory. The memory contains instructions executable by the processing circuitry whereby the network node 24 is configured to perform any of the steps of any of the embodiments described above for the network node 24.

Embodiments herein also include a user plane network node 18 configured to perform any of the steps of any of the embodiments described above for the user plane network node 18.

Embodiments also include a user plane network node 18 comprising processing circuitry and power supply circuitry. The processing circuitry is configured to perform any of the steps of any of the embodiments described above for the user plane network node 18. The power supply circuitry is configured to supply power to the user plane network node 18.

Embodiments further include a user plane network node 18 comprising processing circuitry. The processing circuitry is configured to perform any of the steps of any of the embodiments described above for the user plane network node 18. In some embodiments, the user plane network node 18 further comprises communication circuitry.

Embodiments further include a user plane network node 18 comprising processing circuitry and memory. The memory contains instructions executable by the processing circuitry whereby the user plane network node 18 is configured to perform any of the steps of any of the embodiments described above for the user plane network node 18.

Embodiments herein also include a consumer node 34 configured to perform any of the steps of any of the embodiments described above for the consumer node 34.

Embodiments also include a consumer node 34 comprising processing circuitry and power supply circuitry. The processing circuitry is configured to perform any of the steps of any of the embodiments described above for the consumer node 34. The power supply circuitry is configured to supply power to the consumer node 34.

Embodiments further include a consumer node 34 comprising processing circuitry. The processing circuitry is configured to perform any of the steps of any of the embodiments described above for the consumer node 34. In some embodiments, the consumer node 34 further comprises communication circuitry.

Embodiments further include a consumer node 34 comprising processing circuitry and memory. The memory contains instructions executable by the processing circuitry whereby the consumer node 34 is configured to perform any of the steps of any of the embodiments described above for the consumer node 34.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

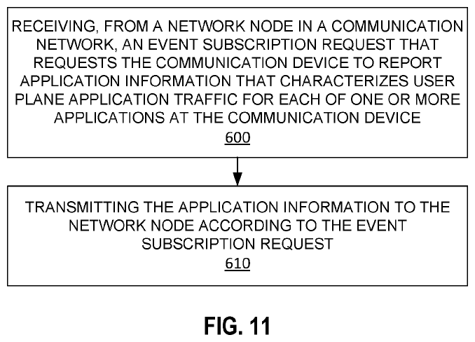

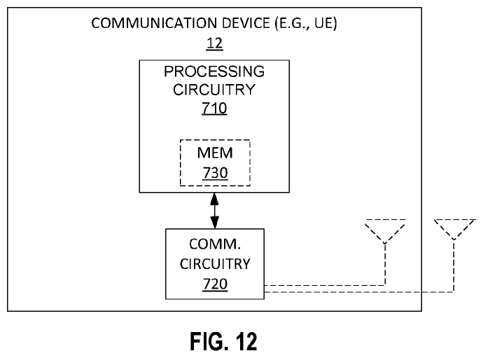

FIG. 12 for example illustrates a communication device 12 as implemented in accordance with one or more embodiments. As shown, the communication device 12 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the communication device 12. The processing circuitry 710 is configured to perform processing described above, e.g., in FIG. 11, such as by executing instructions stored in memory 730. The processing circuitry 710 in this regard may implement certain functional means, units, or modules.

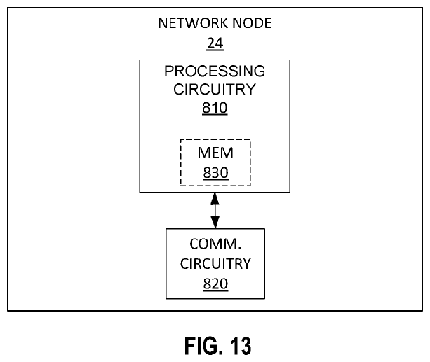

FIG. 13 illustrates a network node 24 as implemented in accordance with one or more embodiments. As shown, the network node 24 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 6, FIG. 8, and/or FIG. 10, such as by executing instructions stored in memory 830. The processing circuitry 810 in this regard may implement certain functional means, units, or modules.

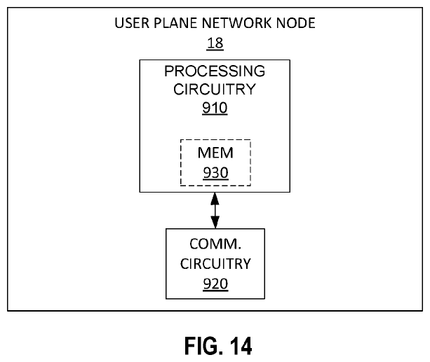

FIG. 14 illustrates a user plane (UP) network node 18 as implemented in accordance with one or more embodiments. As shown, the UP network node 18 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 9, such as by executing instructions stored in memory 830. The processing circuitry 810 in this regard may implement certain functional means, units, or modules.

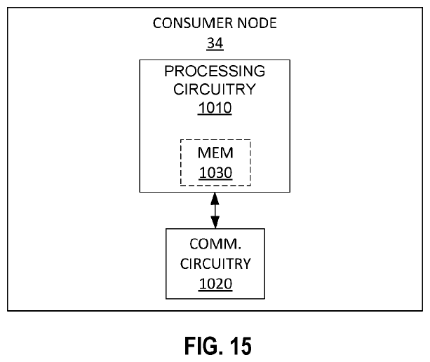

FIG. 15 illustrates a consumer node 34 as implemented in accordance with one or more embodiments. As shown, the consumer node 34 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 7, such as by executing instructions stored in memory 830. The processing circuitry 810 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

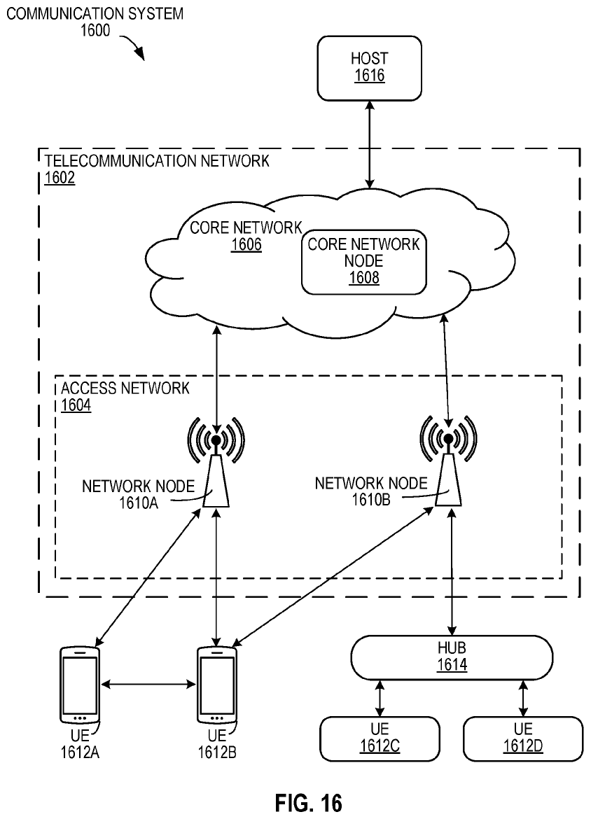

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3rd Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

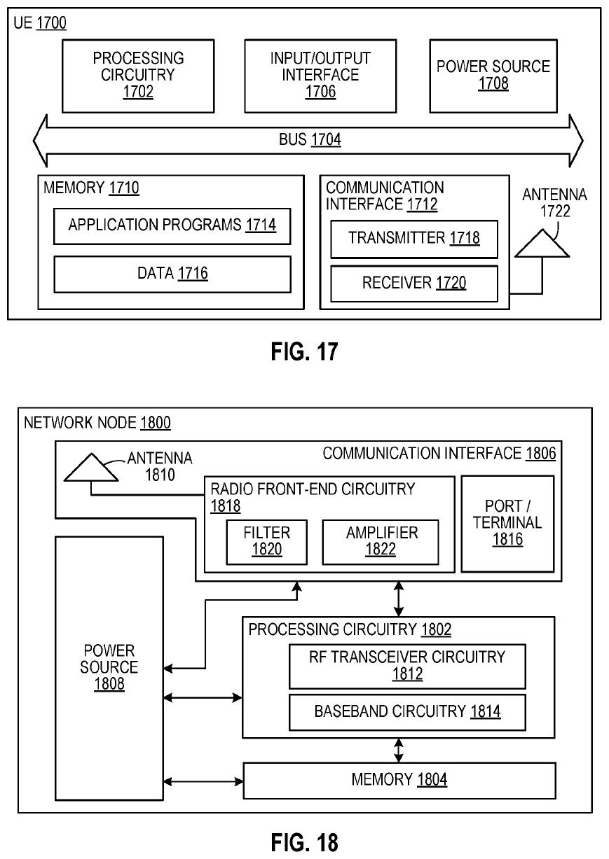

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

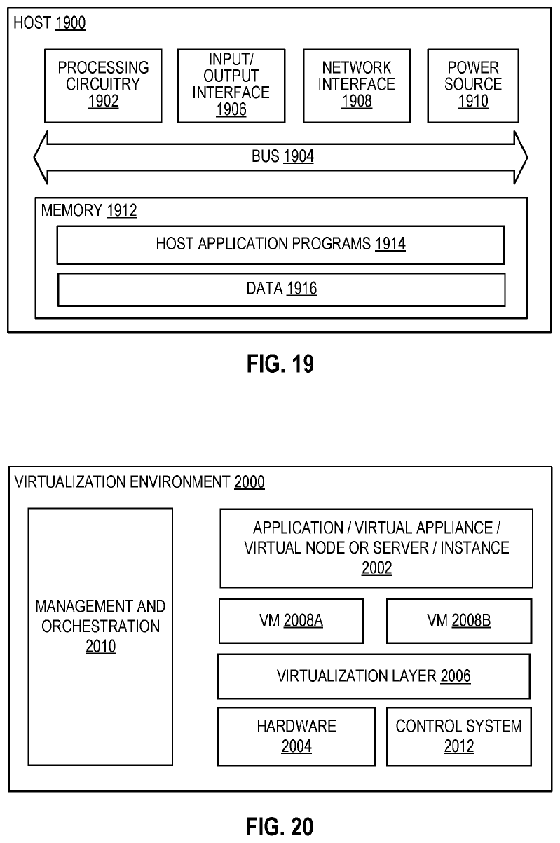

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

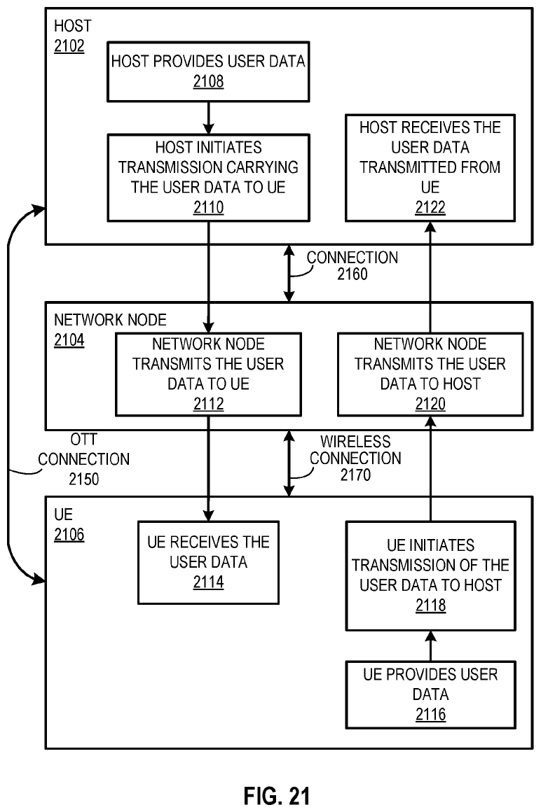

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a network node in a communication network, the method comprising:
receiving, from a consumer node in the communication network, a request for analytics, the request including an analytic identifier parameter, different possible values of the analytic identifier parameter being mapped to different respective types of analytics, the analytic identifier parameter included in the request being set to one of the possible values which is mapped to a type of analytics that characterizes misclassification of user plane application traffic by the communication network, which request characterizes misclassification of user plane application traffic by the communication network;
generating analytics according to the request; and
transmitting the generated analytics to the consumer node as a response to the request.

2. The method of claim 1, further comprising:
receiving network classification information that characterizes classification of user plane application traffic by the communication network; and
determining, based on the network classification information, an extent to which the communication network is misclassifying user plane application traffic, wherein the analytics are generated based on the determined extent.

3. The method of claim 2, wherein the network classification information comprises, for each of one or more applications:
an identifier that identifies the application; and
a copy of user plane application traffic classified as being traffic of the identified application and/or descriptive data that describes the user plane application traffic classified as being traffic of the identified application.

4. The method of claim 2, further comprising receiving, for each of one or more communication devices, device-reported application information reported by the communication device as characterizing user plane application traffic for each of one or more applications at the communication device, wherein said determining is also based on the device-reported application information.

5. The method of claim 2, wherein said determining is also based on a trained machine learning model, wherein the method further comprises training the machine learning model to detect user plane application traffic misclassification based on recognizing patterns in how user plane application traffic classification changes across different traffic classification models and/or application versions.

6. A method performed by a consumer node in a communication network, the method comprising:
transmitting, from the consumer node to a network node in the communication network, a request for analytics, the request including an analytic identifier parameter, different possible values of the analytic identifier parameter being mapped to different respective types of analytics, the analytic identifier parameter included in the request being set to one of the possible values which is mapped to a type of analytics that characterizes misclassification of user plane application traffic by the communication network, which request characterizes misclassification of user plane application traffic by the communication network; and
receiving the analytics from the network node as a response to the request.

7. The method of claim 6, further comprising, based on the analytics, performing one or more actions to one or both account for and mitigate an impact of, user plane application traffic misclassification characterized by the received analytics.

8. The method of claim 7, wherein the one or more actions include one or more of:
triggering re-training of a machine learning model that governs user plane application traffic classification by the communication network;
triggering an alarm or warning indicating occurrence of misclassification of user plane application traffic by the communication network;
increasing a counter indicating a number of occurrences of misclassification of user plane application traffic by the communication network; or
adjusting charging to account for misclassification of user plane application traffic by the communication network.

9. (canceled)

10. The method of claim 6, wherein the request comprises a request for analytics that characterize misclassification of user plane application traffic associated with one or more of:
one or more targeted applications;
one or more targeted communication devices or one or more targeted groups of communication devices;
one or more targeted data network names;
one or more targeted network slices of the communication network;
one or more areas of interest within a geographical coverage area of the communication network; and
one or more access technologies usable for accessing the communication network.

11. The method of claim 6, wherein the analytics indicate:
an extent to which the communication network has misclassified user plane application traffic; and
for which one or more applications and/or for which one or more communication devices user plane application traffic has been misclassified.

12. The method of claim 6, wherein the analytics indicate, for each of one or more applications one or both:
a volume of user plane application traffic misclassified for that application; and
a level of confidence that user plane application traffic has been misclassified for the application.

13. The method of claim 12, wherein the generated analytics further indicate, for each of the one or more applications, one or more of:
a model used for classifying user plane application traffic for that application;
an identity of the application; and
a list of one or more versions of the application for which the generated analytics apply.

14. The method of claim 1, wherein misclassification of user plane application traffic by the communication network comprises misclassification of user plane application traffic for one application as being user plane application traffic for another application.

15. A network node configured for use in a communication network, the network node configured to:
receive, from a consumer node in the communication network, a request for analytics, the request including an analytic identifier parameter, different possible values of the analytic identifier parameter being mapped to different respective types of analytics, the analytic identifier parameter included in the request being set to one of the possible values which is mapped to a type of analytics that characterizes misclassification of user plane application traffic by the communication network, which request characterizes misclassification of user plane application traffic by the communication network;
generate analytics according to the request; and
transmit the generated analytics to the consumer node as a response to the request.

16. The network node of claim 15, further configured to:
receive network classification information that characterizes classification of user plane application traffic by the communication network; and
determine, based on the network classification information, an extent to which the communication network is misclassifying user plane application traffic, wherein the analytics are generated based on the determined extent.

17. A consumer node configured for use in a communication network, the consumer node configured to:
transmit, from the consumer node to a network node in the communication network, a request for analytics, the request including an analytic identifier parameter, different possible values of the analytic identifier parameter being mapped to different respective types of analytics, the analytic identifier parameter included in the being set to one of the possible values which is mapped to a type of analytics that characterizes misclassification of user plane application traffic by the communication network, which request characterizes misclassification of user plane application traffic by the communication network; and
receive the requested analytics from the network node as a response to the request.

18. The consumer node of claim 17, further configured to:
based on the analytics, perform one or more actions to one or both account for and mitigate an impact of, user plane application traffic misclassification characterized by the received analytics.

19.-60. (canceled)
